(19) United States
(12) Patent Application Publication
(10) Pub. No.: US 2006/0243544 A1
(43) Pub. Date: Nov. 2, 2006

(54) Vehicle gearbox with an integrated brake

(76) Inventor: Hermann Sonnleitner, Hauzenberg (DE)

Correspondence Address: DAVIS & BUJOLD, P.L.L.C., 112 PLEASANT STREET, CONCORD, NH, 03301, US

(21) Appl. No.: 10/571,444

(22) PCT Filed: Sep. 25, 2004
(86) PCT No.: PCT/EP04/10798

§ 371 Date: Mar. 13, 2006

(30) Foreign Application Priority Data
Oct. 25, 2003 (DE) 103 49 905.9

(51) Int. Cl. F16D 55/36

(52) U.S. Cl. 188/71.5

(57) ABSTRACT

A vehicle transmission has one integrated brake, the inner rotating discs (4) being non-rotatably connected with a planet carrier (2) which has on its periphery, recesses (9) in which are situated cup-shaped elements (10) which scoop lubricant and transport it to the inner rotating discs (4).

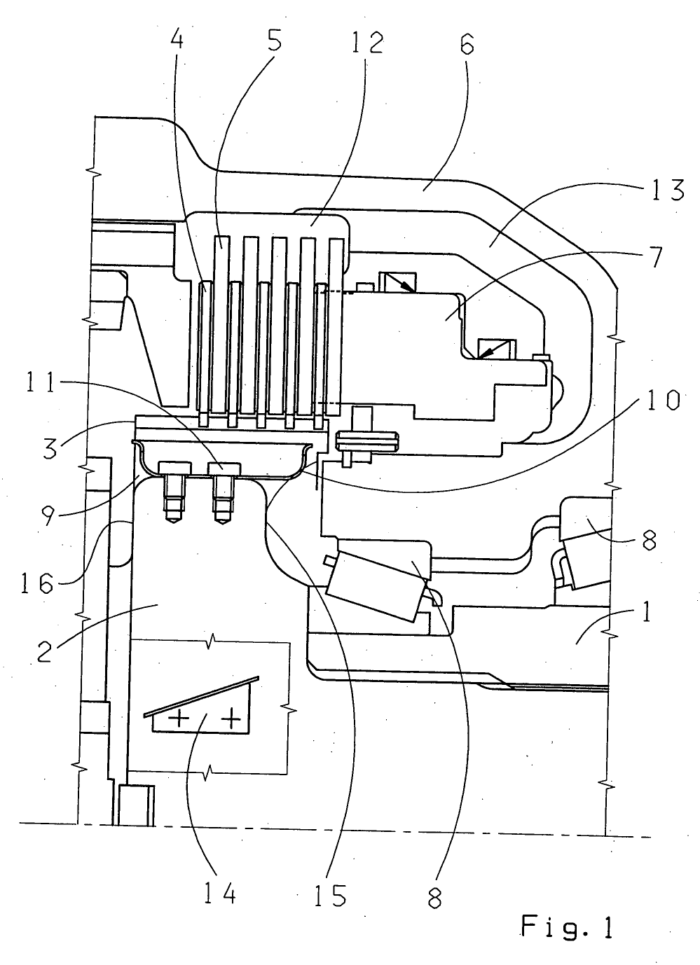

This application is a national stage completion of PCT/EP2004/010798 filed Sep. 25, 2004 which claims priority from German Application Serial No. 103 49 905.9 filed Oct. 25, 2003.

### FIELD OF THE INVENTION

According to the type defined in detail in the preamble of claim 1, the invention relates to a transmission with an integrated brake.

### BACKGROUND OF THE INVENTION

Vehicle transmission with integrated brake have been used as end transmissions in vehicle axles, preferably for working machines of all kinds such as wheel loaders or industrial lift trucks, wheeled or tracked vehicles. Specially in applications where the output in braked state is not to admit any kind of rotational motions due, for example, to toothing plays like in a mobile excavator, the disc carrier of the brake, which is kept non-rotatable when the brake is actuated, is directly connected with the output of the vehicle transmission. Due to the slight differential speed of the brake discs resulting therefrom, sufficient cooling of the brake discs during, before and after the braking operation is of special importance.

DE 197 18 744 C1 discloses a vehicle transmission with an integrated brake where the rotating inner discs are placed in the outer area of the planet carrier and the stationary outer discs in the non-rotatable housing where by rotational movement of the planet carrier the lubricant undergoes a centrifugal acceleration and thus flows through the discs cooling them.

EP 1 234 993 A1 discloses a vehicle transmission with an integrated brake in which the inner rotating discs are located upon the outer periphery of the planet carrier and the stationary discs are connected with the non-rotatably held transmission housing and by rotational movement of the planet carrier lubricant reaches the discs and by centrifugal acceleration in the multi-disc brake is conveyed to the radially outer end of the multi-disc brake.

The problem on which the instant invention is based is, in a vehicle transmission with an integrated brake which is non-rotatably connected with the output, sufficiently to supply the brake with lubricant thus preventing overheating of the brake.

### SUMMARY OF THE INVENTION

According to the invention, the transmission has one multi-disc brake in which discs are non-rotatably connected with a disc carrier which is non-rotatably connected with the output. The disc carrier is in non-rotatable connection with at least one cup-shaped element which absorbs lubricant fluid when the disc carrier rotates and relays it to the discs. The cup-shaped element is here constructed with the disc carrier or with an element connected with the disc carrier in a manner such that by rotation of the disc carrier the cup-shaped element immerses in a lubricant reservoir, thereby fills itself and during further rotation of the disc carrier remains filled until the cup-shaped element exceeds the horizontal center of the disc carrier and thereby the lubricant is poured out of the cup-shaped element and flows toward the discs of the brake. Under high rotational speed, the centrifugal force supports the flowing out of the lubricant from the cup. The lubricant flows here from the cup-shaped element to the inner diameter of the brake discs and via grooves, which are incorporated in the brake discs, is distributed over the surface of the discs. By virtue of the use of cup-shaped elements, in addition to the immersion of the discs in the lubricant pan, lubricant is fed to the multi-disc brake. Several cup-shaped elements uniformly distributed over the periphery are preferably used.

In one other embodiment of the invention, the vehicle transmission has a planetary transmission in which the planet carrier of the planetary transmission is non-rotatably connected with the disc carrier or designed integrally therewith. It is possible to dispose the cup-shaped element in or on the planet carrier or the disc carrier or to design it integrally with the parts. The planet carrier preferably has recesses in which the cup-shaped elements are located. The cup-shaped elements can be made of deep-drawable material such as plastic or steel plate. But it is also possible to design the cup-shaped elements integral with the rotatable parts. It is possible to produce the latter, for example, by casting or forging. In another embodiment of the invention, on rotatable parts of the vehicle transmission conductor elements are situated which produce a purposeful flow of the lubricant within the vehicle, thereby resulting an immersion of the lubricant in the immediate proximity of the brake. It is thus ensured that the cup-shaped elements can absorb almost cooled lubricants. If the vehicle transmission is situated in a drive axle, a purposeful flow of the lubricant is obtained from the axle bridge to the spaces in immediate proximity of the brake by using the conductor elements. Specially in the area of the axle bridge, it is possible for the lubricant to be cooled and be able again to flow back to the multi-disc brake. Except for the cup-shaped elements, the vehicle transmission can be designed like the vehicle transmission of DE 197 18 744 C1 and of EP 1 234 993 A1 which are to be entirely included here.

### BRIEF DESCRIPTION OF THE DRAWING

The invention will now be described, by way of example, with reference to the accompanying drawing in which:

The single FIGURE shows one section of a vehicle transmission with an integrated brake.

### DETAILED DESCRIPTION OF THE INVENTION

The single FIGURE shows one section of a vehicle transmission with an integrated brake such as that shown in DE 197 18 744 C1. One output flange 1 is non-rotatably connected with a planet carrier 2 which is integrally connected with a disc carrier 3. The disc carrier 3 holds, on its radially outer periphery, an inner rotating discs 4 of a multi-disc brake 5. The outer stationary discs 5 are non-rotatably held in a housing 6. By actuating a piston 7, the multi-disc brake can be actuated in opening and closing direction. The output flange 1 is supported in the transmission housing 6 via a bearing 8. The planet carrier 2 has in a radially outer area recesses 10 where cup-shaped elements 19 are located. These can be either non-rotatably connected with fastening elements 11 or designed integrally with the planet carrier 2. By rotation of the planet carrier 2, the cup-shaped elements 10, which are preferably uniformly situated on the periphery of the planet carrier 2, reach a lubricant pan (not shown), whereby the cup-shaped elements are filled with lubricant. By further rotation of the planet carrier 2, the lubricant reaches over the lubricant pan and is flung by gravity and by centrifugal force out of the cup-shaped elements 10. Thereby the lubricant reaches the inner rotation discs 4 and is uniformly distributed between the discs 4 and 5 through the grooves in the inner rotating discs 4 or the outer stationary discs 5. By centrifugal acceleration, the lubricant ultimately reaches a space 12 located on the radial end of the stationary outer discs 5 whereby the lubricant can again flow back via a duct 13 to the planet carrier 2. In another embodiment, one conductor element 14 is situated upon the planet carrier 2, which can be designed integral with the planet carrier 2 or as a separate part and which, upon rotation of the planet carrier 2, produces a flow in the lubricant pan. By the flow into the lubricant pan, the lubricant is immersed in immediate proximity of the tapping point of the cup-shaped elements 10 whereby cooled lubricant reaches the cup-shaped elements 10. In one other embodiment of the invention it is possible to situate the cup-shaped elements on an axial side 15 or an axial side 16 whereby lubricant is, likewise, removed from the lubricant pan and reaches the inner side of the inner rotating discs 4. It is thus ensured that the multi-disc brake is sufficiently and uniformly supplied with lubricant or coolant.

### REFERENCE NUMERALS

1 output flange
2 planet carrier
3 disc carrier
4 inner rotating discs
5 outer rotating discs
6 transmission housing
7 piston
8 bearing
9 recesses
10 cup-shaped elements
11 fastening elements
12 space
13 duct
14 conductor element
15 axial side
16 axial side

1-9. (canceled)

10. A vehicle transmission having an integrated brake in which a disc carrier (3) is non-rotatably connected with an output (1) of the transmission and with discs (4) of a brake, the disc carrier (3) is non-rotatably connected with at least one cup-shaped element (10) which upon rotation of the disc carrier (3) absorbs lubricant fluid and relays the fluid lubricant to the discs (4) of the brake, conductor elements (14) are situated upon one of the disc carrier (3) and the planet carrier (2), upon rotation of the disc carrier (3), the conductor elements (14) produce lubricant flow, the vehicle transmission is integrated in a drive axle with drive gears and by the conductor elements (14), revolution and immersion of the lubricant occurs due to an immediate surrounding of the brake with the lubricant.

11. The vehicle transmission with integrated brake according to claim 10, wherein the disc carrier (3) is one of non-rotatably connected with a planet carrier (2) of a planetary transmission and integral therewith.

12. The vehicle transmission with integrated brake according to claim 11, wherein the planet carrier (2) has recesses (9), on its outer periphery, where the cup-shaped elements (10) are located.

13. The vehicle transmission with integrated brake according to claim 11, wherein the planet carrier (2) has recesses (9), on an outer periphery, which are designed as the cup-shaped elements (10).

14. The vehicle transmission with integrated brake according to claim 10, wherein the cup-shaped elements (10) are produced from a deep-drawable material.

15. The vehicle transmission with integrated brake according to claim 11, wherein an outer central gear of the planetary transmission is non-rotatably connected with a transmission housing.

16. The vehicle transmission with integrated brake according to claim 10, wherein the discs (4, 5) have grooves through which the lubricant fluid flows.
